(19) United States
(12) Patent Application Publication
(10) Pub. No.: US 2013/0168186 A1
(43) Pub. Date: Jul. 4, 2013

(54) HOISTING DEVICE AND A COMPONENT MODULE FOR A HOISTING OR TRANSFERRING DEVICE

(71) Applicant: Vesa Valtonen, Lempaeaelae (FI)

(72) Inventor: Vesa Valtonen, Lempaeaelae (FI)

(73) Assignee: W-M ENGINEERING OY, Tampere (FI)

(21) Appl. No.: 13/821,771

(22) PCT Filed: Sep. 13, 2011
(86) PCT No.: PCT/FI11/50785

§ 371 Date: Mar. 8, 2013

(30) Foreign Application Priority Data
Sep. 14, 2010 (FI) 20105944

(51) Int. Cl. B66F 11/04; E04G 1/22; B66F 7/16

(52) U.S. Cl. CPC B66F 11/04; B66F 7/16; E04G 1/22
USPC 182/113; 182/141; 254/2 C

(57) ABSTRACT

A hoisting device, comprising a base structure; a work platform structure, and at least one cylinder coupled between the base structure and the work platform structure; at least one chamber with a variable volume, for pressurized medium, configured to elevate the work platform structure by utilizing the pressurized medium enclosed in the chamber; and at least one pulling device configured to pull down the work platform structure. In an example, the hoisting device further comprises at least one auxiliary chamber intended for the pressurized medium, connected to the chamber of the cylinder, and placed inside the base structure or the work platform structure, or in the structure of the cylinder. A component module for a hoisting or transferring device comprises a cylinder and a base structure. In the method, variation of the pressure in the chamber of the cylinder is allowed.

### FIELD OF THE INVENTION

The invention relates to a hoisting device. The invention also relates to a component module for a hoisting or transferring device. Furthermore, the invention relates to a method in a hoisting device.

### BACKGROUND OF THE INVENTION

In various works, such as construction, repairing and maintenance works, various movable hoisting devices are used for lifting a person to a desired height level to perform the work.

In said hoisting devices, for example compressed air is applied as a pressurized medium effective on telescopic pneumatic cylinders for lifting loads, such as persons and tools. The compressed air has a given pressure level, for example 6 bar, and when the compressed air is fed into the cylinder, the pressure is effective on the inner surfaces of the cylinder in such a way that forces are generated which tend to extend the cylinder in its longitudinal direction. Said forces effective in the longitudinal direction of the cylinder are also transferred by the cylinder to the load connected to the cylinder, which load can thus be moved, for example elevated. The total force effective on the load depends in a known way on the product of the pressure level and the surface area. The effective surface area on which the pressure acts to extend the cylinder, depends on the structure of the cylinder and is typically equal to the surface area of the moving piston of the cylinder or the largest cross-sectional area of the inner part of the cylinder. The total force has to be sufficiently high to overcome an opposite force caused by the load and further to transfer the load by extending the cylinder. Opposite forces are also generated by friction caused by the cylinder and the load. The required total force can be determined in a way known as such, for example by applying the power balance equation of the cylinder.

For example, if the pressure level is 6 bar (600 kPa, 600 kN/m²) and the effective surface area of one cylinder is 0.002 m², the power to be generated is 1.2 kN, which is sufficient for supporting a load of about 120 kg. In a corresponding manner, with two corresponding cylinders, said force can be carried by a pressure of only 3 bar.

Document DE-3909370-A1 discloses an example of a telescopic cylinder which is single acting in such a way that compressed air is used to extend the cylinder. The cylinder is contracted mechanically by using, for example, a winch and a cable. The cylinder can also be locked in a desired length by the winch. Document EP-0016921-A1 also discloses a telescopic cylinder which is coupled by a hose to a pressure tank. The cylinder is contracted mechanically by using, for example, a winch and a cable. Document US-2009/0057636-A1 discloses a lift device with a telescopic cylinder which is subject to constant pressure by a medium. The cylinder is allowed to extend by the effect of pressure, or the cylinder is retracted by means of a winch and a cable, by which the cylinder can also be locked in a desired length. The cylinder is connected by a hose to a pressure reservoir which is thus used as a storage for the medium during the use of the lift device. By means of cylinders, a lifted platform and a frame, a portable lift device is formed. The cylinders and pressure reservoirs are connected to the frame equipped with wheels.

### BRIEF SUMMARY OF THE INVENTION

The aim of the invention is to eliminate problems and drawbacks of the above-mentioned cylinders and particularly hoisting devices constructed by applying them, for example aerial work platforms.

The hoisting device according to the invention is presented in claim 1. The component module according to the invention is presented in claim 15. The method according to the invention is presented in claim 19.

In the hoisting device, hoisting is effected by means of a pressurized medium, and lowering by means of a mechanical retractor. The pressure of the medium is maintained constantly, and the lowering is performed by applying the retractor to generate a force to compress the medium.

An example of the solution has the significant advantage of a simple hoisting structure, in which the closed cylinder space is utilized for storing the pressurized medium. The pressure and the compressibility of the medium are utilized in elevating and lowering the work platform of the hoisting device. With the presented arrangement, the use and transportation of separate pressure tanks and connecting them to the cylinder are avoided.

In another example of the solution, a significant advantage is the simple integrated structure of the hoisting device, where the cavities, chambers or corresponding closed inner spaces are utilized for storing the pressurized medium. The pressurized medium in these spaces is in connection with the chamber of the medium in the cylinder. The connection is preferably free in such a way that the medium can move freely from the space into the cylinder when the cylinder is expanding, and from the cylinder into the space when the cylinder is retracting. The presented arrangement avoids the use and transportation of separate pressure tanks and connecting them to the hoisting device.

In the solution according to a third example, the chamber is an auxiliary chamber connected to or integrated in the cylinder structure and in connection with the chamber of the medium in the cylinder. The auxiliary chamber is in use either alone or together with the other chambers, operating according to their principles.

In the presented solutions, also a retractor, for example a winch, that can be controlled by e.g. a motor, is utilized for controlling the length of the cylinder. By means of the retractor, the cylinder can also be locked in a desired length, which also stabilizes the cylinder.

In particular, the presented solution utilizes hollow tubular structures which provide spaces for storing the pressurized medium. By utilizing various spaces, a large total volume of the medium is achieved, particularly compared with the volume of a conventional cylinder, wherein the pressure variations of the medium are smaller. The pressure variations result from changes in the volume of the cylinder. The dependence of the pressure variations on the change in the volume is known as such from the dependence presented, for example, in Boyle's law. The large total volume of the medium can also be achieved by a separate pressure reservoir according to the prior art, involving large pressure reservoirs which are difficult to use.

The presented solution provides a discrete hoisting device which is independent of medium distribution networks and which can also be transferred to a site without a medium distribution network available. The use of separate pressure reservoirs is also avoided with the solution.

With the presented solution, it is possible to construct a safe, low-pressure system that is well suited for construction, repair and maintenance works. The system is particularly a passenger hoist. The hoisting force required of the hoisting device can be easily determined by selecting one or more cylinders with a sufficient effective surface area for use. The applied pressure is typically lower than 6 bar, which is easily available. Preferably, the pressure is 2 to 3 bar, at the lowest even 0.5 bar or lower.

By the presented solution, it is also easy to lower the hoisting device quickly, for example in an emergency situation. The necessary element is, for example, a simple mechanical shut-off valve which normally remains shut off, for example by means of a preloaded spring, and which opens up a channel from said space to fresh air when pressed down. Now, said valve is also easy to place in the top of the hoisting device, within the reach of the person to be supported, because said space for the medium is provided, for example, within guards or railings supporting the person. In the prior art, such a valve is provided, for example, in the lower part of the hoisting device, where the supply of medium to the cylinder is provided and which is normally not within the reach of the person to be supported.

In an example of the solution, the retractor is shielded inside the cylinder, wherein the retractor is also safe for the user. In an example of the solution, a compressor or a blower for producing the compressed medium is also placed in the structure of the hoisting device.

In an embodiment of the solution, modularity is utilized in the structure of the frame, the cylinders and the work platform of the hoisting device, for example in such a way that a desired number of cylinder modules or base structure modules can be combined to various work platform modules. In this way, it is possible to construct various hoisting devices for different uses, particularly to vary their hoisting capacity.

In an embodiment, the cylinder and the base structure formed by the frame constitute a universal module which can also be applied to various uses, in which the load is to be moved for example horizontally and/or vertically, depending on the application. For example, various work platforms or tables for manipulating loads, particularly for lifting and lowering, can be connected to the module. The load consists of discrete loads as well as the structures connected to the module. The space for the pressurized medium is provided inside the cylinder, in its working chamber and, if necessary, also elsewhere in the structure of the cylinder or inside the base. Preferably, the retractor is also shielded inside the base and the cylinder, forming a compact structure. The module also comprises the necessary equipment and control devices and connections.

In an example, the cylinder can also be coupled to a portable structure in such a way that a closed space inside said structure can also be utilized as a storage of pressurized medium.

### DESCRIPTION OF THE DRAWINGS

In the following, the invention will be described by means of some examples and with reference to the appended drawings, in which

FIG. 1 shows an example of a hoisting device in its lowest position,

FIG. 2 shows the hoisting device according to the example of FIG. 1 in its uppermost position,

FIG. 3 shows a module consisting of a base, a cylinder and a retractor, by way of example, and

FIG. 4 shows an example solution of the operation of the hoisting device.

### DETAILED DESCRIPTION OF THE INVENTION

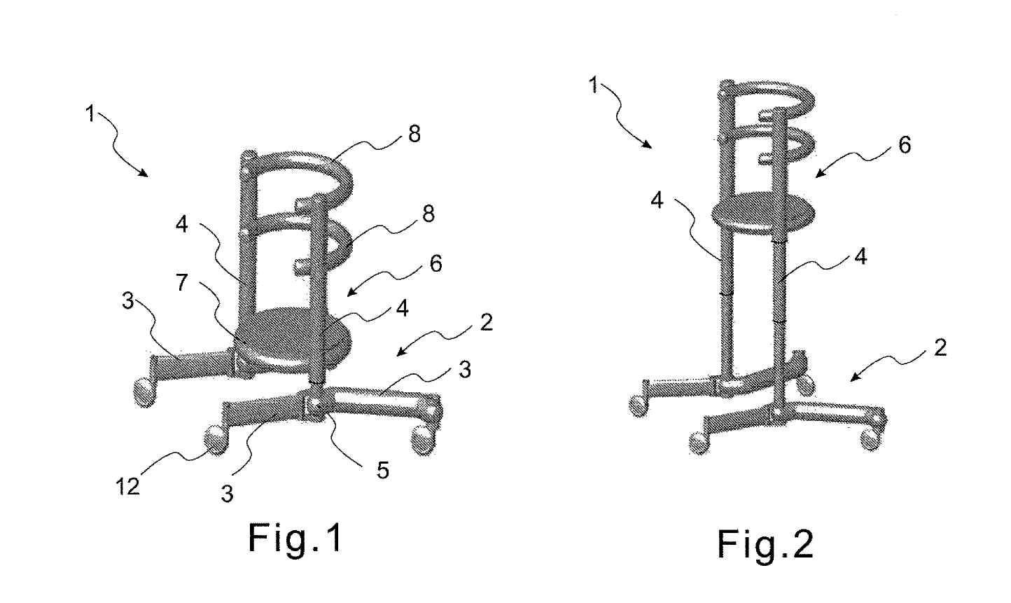

FIG. 1 shows an embodiment of the present solution, in the case of a hoisting device 1 used for lifting one person. The hoisting device comprises a base 2 that carries and supports the hoisting device 1, and keeps it upright and sufficiently stable. Preferably, the structure of the base 2 comprises, for example, wheels 12, by means of which the hoisting device 1 can be transferred along a suitable planar ground, for example a floor. In the presented example, the base 2 further comprises supporting legs 3 which can be turned into a desired position and whose function is to stabilize the hoisting device 1. In the presented example, the supporting legs 3 can also be turned into a transportation position in such a way that the base 2 becomes as compact and small as possible, which facilitates the transportation and packing into a transport vehicle.

In an example, the structure of the base 2, for example its frame 5 and/or its one or more supporting legs 3, delimit a closed chamber to which pressurized medium has access. Preferably, the frame 5 and/or the supporting leg 3 are made of a tube whose hollow interior constitutes said chamber. It is also possible to utilize various beams or housings which constitute the structure of the hoisting device and have a hollow interior.

The hoisting device 1 of FIG. 1 comprises two vertical cylinders 4 which are telescopic and single acting. Each cylinder 4 comprises a set of cylinder tubes placed within each other and being capable of moving in relation to each other in a sealed manner. Preferably, a continuous chamber is formed for the pressurized medium inside most or all of the cylinder tubes. There are two or more cylinder tubes, depending on the desired hoisting height of the hoisting device 1 and the length of the cylinder tubes. The number and size of the cylinders 4 depend on the desired pressure level and the maximum load capacity sought for the hoisting device 1. For example, the cylinder diameter is 40 to 150 mm, or larger.

The chamber of the cylinder 4 is in direct contact with, for example, the chambers of the medium in the structure of the base 2. A channel or duct at the end of the cylinder 4 connects the chamber of the cylinder 4 to the chamber of the base 2, when the cylinder 4 is connected to the base 2, or said connection is formed by a separate tube or hose.

In an example, the work platform 6 can be lifted by the cylinder 4 to a height of 2.7 to 3.3 m. The sought load capacity to be lifted is about 120 kg. The work platform 6 is connected to the end or upper part of one or more cylinders 4, either directly or via another structure belonging to the work platform 6.

In an example, the structures of the work platform 6, for example its frame 7 and/or its one or more horizontal or vertical rails 8, delimit a closed chamber to which pressurized medium has access. Preferably, the frame 7 and/or the rail 8 are made of a tube whose hollow interior constitutes said chamber.

The chamber of the cylinder 4 is in direct contact with, for example, the chambers of the medium in the structure of the work platform 6. A channel or duct at the end of the cylinder 4 connects the chamber of the cylinder 4 to the chamber of the work platform 6, when the cylinder 4 is connected to the work platform 6, or said connection is formed by a separate tube or hose.

In the example shown in the figure, the upper end of the cylinder 4 forms a part of the structure of the work platform 6, and the rails 8 are connected directly to the vertical cylinder 4. The rails 8 are used to support a person standing on the frame 7. In addition to the rails 8, it is possible to use a gate that can be closed and opened, to increase safety.

Control means are also placed within the reach of the person standing on the frame 7, for controlling the operation of the hoisting device 1. They are, for example, electrically functioning switching means for controlling the hoisting device 1 to descend or ascend. The electrical power needed by the hoisting device 1 is preferably stored in at least one battery 20 that is placed in either the work platform 6 or the base 2. In particular, the switching means are used for controlling one or more electric retractors. In one example, a battery loading device that can be connected to an external electrical network is also provided in connection with the battery. The retractor is effective between the base 2 and the work platform 6, forcing the cylinder 4 to retract by the effect of the pulling force of the retractor, or enabling the extension of the cylinder 4 by the effect of the pressure of the medium. The retractor generates a counter force to the force generated by the medium. The pressure of the medium and the force generated by it are constantly effective in the hoisting device. The pressure may vary according to the total volume subject to the pressure. When the counter force is greater than the force generated by the medium, the work platform 6 can be moved lower, closer to the base 2 and the floor.

In an example, the control means are mechanical, wherein the retractor operates mechanically. Thus, an actuator, such as a crank handle, is provided within the reach of and available to the person standing on the work platform 6, for operating the retractor. In an example, the actuator can be coupled to a drilling machine or a screwdriver equipped with a battery to provide the driving force for operating the retractor. Thus, for example a winch is placed in the work platform 6, and the end of a cable or a cord used as a flexible pulling member of the winch is connected to the base 2, or the pulling member is connected to the work platform 6 but it is also coupled to the base 2, for example by means of one or more idler wheels. The hoisting device according to this example is independent of electric energy.

Several pulling devices can be used, wherein their operation is preferably synchronized. The pulling device can also be connected to the base 2. Thus, for example the winch can be placed in the base 2, and the end of the pulling member is connected to the work platform 6, or it is connected to the base 2 but the pulling member is also connected to the work platform 6, for example by means of one or more idler wheels.

In FIG. 1, the hoisting device 1 is in a state in which the pressurized medium is compressed into a smaller volume than in FIG. 2; the retractor keeps the work platform 6 in the lowest position in such a way that it is possible to step onto the frame 7. In FIG. 2, the hoisting device 1 is in a state in which the pressurized medium has expanded and lifted the work platform 7 to its uppermost position in such a way that it is possible to work on the frame 7. The retractor has enabled the extension of the cylinder 4 and locked the cylinders 4 to be stationary. The pressure of the medium has been adjusted so that the hoisting device 1 is sufficiently rigid and stable in the position shown in FIG. 2.

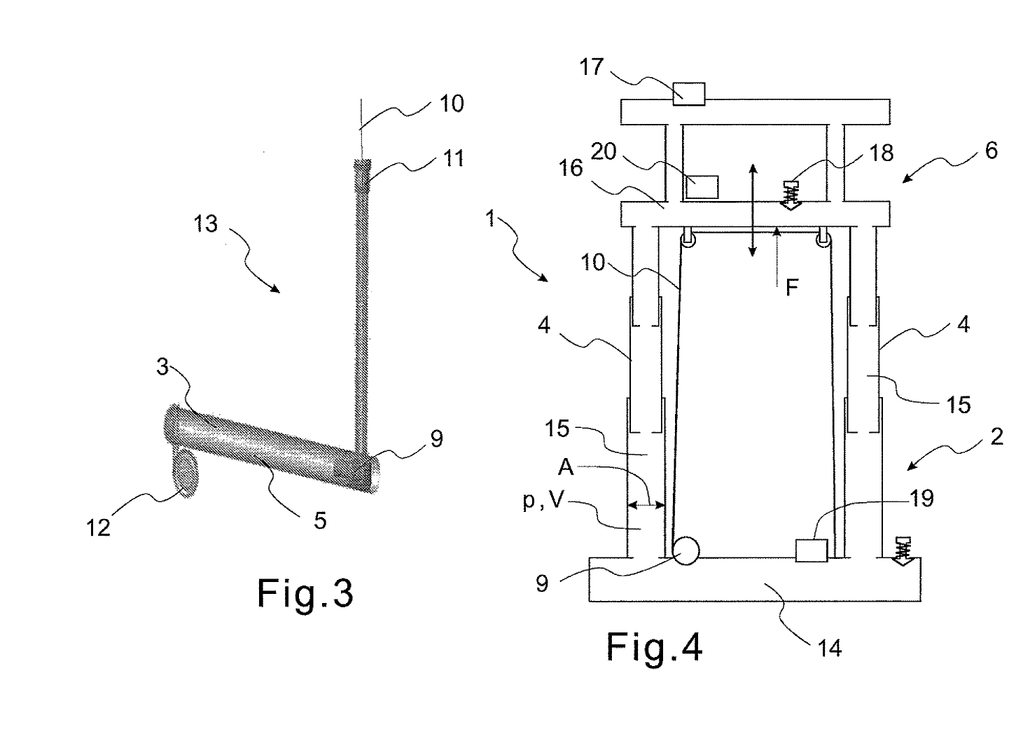

FIG. 3 shows a more detailed view of a retractor 9 which is a winch equipped with a pulling member 10, for example a coilable wire or cord. The pulling device 9 is protected inside the structure of the base 2. In an example, the pulling device 9 is placed inside a chamber or cylinder of pressurized medium, and the necessary electrical through holes, or the like, are pressure-sealed. In this example, the cylinder 4 and the base 2 make up a component, or a module, which can be used for different purposes. Of the telescopic cylinder, only the outermost stage of the cylinder or the cylinder tube 11 connected to the base 2 is shown in FIG. 3. The other cylinder tubes are connected around the cylinder tube 11. The pulling member 10 extends inside the cylinder tubes from the pulling device 9 and is connected to the outermost cylinder tube, for example its outermost end, or to a structure of the work platform 6.

The component shown in FIG. 3 is particularly a base component for the hoisting device 1, acting as a leg 3 for the hoisting device 1. According to the example shown in FIG. 3, a wheel 12 is also connected to the frame 5. In an example, auxiliary supporting legs shown in FIG. 1 can also be connected to the base component 13 presented. Preferably, the base component also comprises said chamber for the pressurized medium. The base component comprises a frame 5 used as the leg 3, a pulling device 9 together with a pulling member 10, and a cylinder 4.

Further, FIG. 4 illustrates the structure of the hoisting device 1 comprising a chamber 14 placed inside the base 2, a chamber 15 placed inside the cylinder 4, and a chamber 16 placed inside the work platform 6. In this example, all the chambers 14, 15 and 16 are connected to each other. The chamber 14 is connected to the chamber 16 via the cylinder 4 and the chamber 15. In one example, the chambers 14 and 16, which can also be called auxiliary chambers, are in direct contact by a separate hose, and only either the chamber 14 or the chamber 16 is directly connected to the chamber 4. However, the advantage of not needing separate hoses is achieved by the arrangement according to FIG. 4. In another example, the cylinder 4 comprises two or more separate chambers which are not connected to each other and there is no connection between the chamber 14 and 16 via the cylinder 4. However, the cylinder 4 is configured in such a way that the pressurized medium can be transferred between the cylinder tubes to enable telescopic movement of the cylinder. The chamber 14 of the base 2 and at least one chamber of the cylinder 4 are connected to each other, enabling the hoisting of the work platform 6. The chambers 14 and 16 can be directly connected, for example by means of a separate hose.

The pressure in the chambers generates a force F hoisting the work platform 6 and sufficient to carry the weight of the work platform 6 as well as the equipment connected to it, the person to be hoisted, and the necessary tools, which together and separately make up the load to be transferred by the hoisting device. The force F is generated by the pressure p of the medium, acting on the effective surface area A of the cylinders 4. The pressurized medium is in a volume V which is at its maximum when the work platform 6 is in its uppermost position and at its minimum when the work platform 6 is in its lowermost position.

FIG. 4 also shows the hoisting device 9 connected to the base 2, and the pulling member 10 coupled to the work platform by idler wheels, the end of the pulling member being connected to the base 2. With a corresponding arrangement, the hoisting device 9 and the pulling member can also be connected to the work platform 6. The control means 7 are connected to the pulling member 10 for controlling the hoisting and lowering.

A valve 18 for discharging the medium from one or more chambers is also illustrated in FIG. 4. The valve 18 is preferably placed within the reach of the person on the work platform 6, for example in connection with the chamber 16. Alternatively or in addition, a valve is also placed in connection with the chamber 14 in the base. The valve is, for example, a shut-off valve pretensioned by a spring, for example a poppet valve which is opened when the valve is pressed down.

The structure of the hoisting device 1 is made of, for example, aluminium, to reduce the weight. A required number of ducts or corresponding connections are provided in connection with each chamber 14, 15 and 16, through which ducts it is possible to supply pressurized medium into the chamber or discharge it from the chamber. During the use of the hoisting device 1, no separate pressure source or pressure reservoir is applied, but pressurized medium stored in the chambers 14, 15 and 16 and its potential energy in the form of pressure is utilized.

The chamber 15 is for example the working chamber of the cylinder where the piston of the cylinder moves. If an auxiliary chamber is connected to or integrated in the structure of the cylinder 4, it is applied, with respect to the operation as well as the structure, in the same way as the above-presented chamber 14 or 16. The auxiliary chamber is typically connected to the chamber 15. Said auxiliary chamber can be used either alone or together with the chamber 14 or 16 in the hoisting device 1. Alternatively, either the chamber 14 or 16, or both of them, can be used in the hoisting device 1.

The pressure of the medium varies with the length of the cylinder 4, and with the volume of the chamber 15. When the work platform is in the elevated position, the pressure level is at the above-presented level in order to achieve a sufficient hoisting force, and when it is in the lowered position, the pressure of the compressed medium substantially rises as the chamber 15 becomes smaller. Preferably, the pressure of 6 to 8 bar is achieved, or the pressure is higher. The cylinder 4 and its chamber 15 are not connected to a separate pressure source or pressure container whose function would also be to level out pressure variations. If the other chambers, for example the chamber 14 or 16, or the auxiliary chamber, are in use, they are not connected to said pressure source or pressure reservoir either. Typically, the volume of the chambers 14 and 16 and the auxiliary chamber does not change during the operation as the volume of the chamber 15 does. The hoisting force is constantly effective, thanks to the pressure of the medium enclosed in the chamber 15. The volume of the medium enclosed in the chamber 15 can be increased by means of the other chambers or the auxiliary chamber, so that there is less variation in the pressure.

In an example, a compressor or a blower 19 is also placed in the structure, or module, of the hoisting device, for generating pressurized medium in one or more chambers. The compressor or blower 19 is selected according to the desired pressure level and the quantity of air needed. The compressor or blower is used to compensate for leaks and/or for loading an unpressurized chamber to a desired pressure. In an example, the compressor or blower 19 is powered by a battery 20 of the hoisting device, or it can be connected to an external electrical power network. In an example, the compressor is placed at least partly inside a chamber of pressurized medium or the cylinder.

In an example, the chamber is loaded to the desired pressure when the cylinder is in its extended position, or when the work platform is elevated, wherein the loading pressure level can be kept low. For loading, it is also possible to utilize said blower or compressor, after which the cylinder or chamber can also be closed or plugged. In an example, it is sufficient that air has access to the cylinder or chamber, when the cylinder is in its extended position, preferably in its maximum length, after which the cylinder or chamber is closed or plugged. The cylinder is selected in such a way that in a position that is shorter than the extended position but is still sufficient for the sought hoisting height, the pressure of the chamber is sufficient for the sought hoisting force. The pressure of the chamber has increased sufficiently during the retraction of the cylinder.

In different applications, the number and volume of the chambers, the number of cylinders, the size of the cylinder, and the pressure level used, as well as the allowed change in the pressure level will vary, and at the same time, they are interdependent. The dimensions are influenced by the sought capacity and the mode of operation of the hoisting device.

The invention is not limited solely to the above-presented examples or alternatives, but it can also be applied within the scope of the appended claims.

1.-16. (canceled)

17. A hoisting device comprising:
a base structure supporting and carrying the hoisting device;
a work platform structure carrying the load, such as a person, to be hoisted and lowered;
at least one cylinder coupled between the base structure and the work platform structure and comprising at least one chamber with a variable volume for pressurized medium; and
at least one pulling device configured to pull the work platform structure to a lowered position and to keep the work platform structure in the desired position;
wherein said cylinder is configured to transfer the work platform structure to an elevated position by utilizing pressurized air closed in said chamber of the cylinder, wherein the pressure of the pressurized air is configured to constantly generate a force elevating the work platform structure and the load;
wherein said pulling device is configured for the lowering to generate a force that opposes the force generated by the pressurized air; and
wherein at least during the elevating and lowering of the work platform structure, the cylinder and the chamber of the cylinder are configured to be without a connection to a separate pressure source or pressure reservoir, wherein the pressure of the pressurized air varies with the length of the cylinder or the volume of the chamber of the cylinder.

18. The hoisting device according to claim 17, wherein the hoisting device further comprises at least one auxiliary chamber for the pressurized air and configured to be without a connection to a separate pressure source or pressure reservoir, wherein said auxiliary chamber is connected to the chamber of the cylinder and is placed inside the work platform structure.

19. The hoisting device according to claim 17, wherein the hoisting device further comprises an auxiliary chamber for the pressurized air and configured to be without a connection to a separate pressure source or pressure reservoir, wherein the auxiliary chamber is integrated in or connected to the structure of the cylinder, wherein said auxiliary chamber is connected to the chamber of the cylinder.

20. The hoisting device according to claim 18, wherein the work platform structure comprises at least one stanchion or railing, and at least part of the auxiliary chamber is placed inside said stanchion or railing.

21. The hoisting device according to claim 17, wherein the hoisting device further comprises at least one auxiliary chamber for the pressurized air and configured to be without a connection to a separate pressure source or pressure reservoir, wherein said auxiliary chamber is connected to the chamber of the cylinder and is placed inside the base structure.

22. The hoisting device according to claim 21, wherein the base structure comprises at least one leg, and at least part of the auxiliary chamber is placed inside said leg.

23. The hoisting device according to claim 17, wherein the work platform structure is provided with a shut-off valve that can be opened to release pressurized air.

24. The hoisting device according to claim 17, wherein the hoisting device further comprises a compressor or a blower for generating pressurized air and further configured to compensate for leaks or to load the chamber of the cylinder to a desired pressure such that, during said elevating and lowering of the work platform structure, the chamber of the cylinder is configured to be without a connection to a separate pressure source or pressure reservoir.

25. The hoisting device according to claim 17, wherein a cavity, chamber or closed space left inside the structure of the hoisting device is configured to store the pressurized air and to be connected to the chamber of the cylinder.

26. The hoisting device according to claim 17, wherein said at least one cylinder is configured to hoist a load of about 120 kilograms to a height of 2.7 to 3.3 metres.

27. A component module for a hoisting or transferring device, comprising:
a base structure supporting and carrying the component module;
at least one cylinder coupled to the base structure and comprising at least one chamber with a variable volume for pressurized medium; and
at least one pulling device configured to return the load or the structure acting as a load by pulling, and to keep the load in a desired position;
wherein said cylinder is configured to elevate or transfer the load by utilizing pressurized air enclosed in said chamber of the cylinder, wherein the pressure of the pressurized air is configured to constantly generate a force elevating or transferring the load; and
wherein said pulling device is configured for the returning to generate a force that opposes the force generated by the pressurized air; and
wherein at least during the elevating, transferring and returning of the load, the cylinder and the chamber of the cylinder are configured to be without a connection to a separate pressure source or pressure reservoir, wherein the pressure of the pressurized air varies with the length of the cylinder or the volume of the chamber of the cylinder.

28. The component module according to claim 27, wherein the component module further comprises at least one auxiliary chamber for the pressurized air and configured to be without a connection to a separate pressure source or pressure reservoir, wherein said auxiliary chamber is connected to the chamber of the cylinder and is placed inside the base structure.

29. The component module according to claim 28, wherein the base structure comprises at least one leg, and at least part of the auxiliary chamber is placed inside said leg.

30. The component module according to claim 27, wherein the component module further comprises at least one auxiliary chamber for the pressurized air and configured to be without a connection to a separate pressure source or pressure reservoir, wherein said auxiliary chamber is connected to the chamber of the cylinder and is placed inside the structure of the cylinder.

31. The component module according to claim 27, wherein the pulling device is configured inside the cylinder and the base structure.

32. A method in a hoisting device, comprising:
supporting and carrying the hoisting device by using a base structure;
carrying a load to be hoisted and lowered, such as a person, by using a work platform structure;
storing pressurized medium in at least one cylinder which is coupled between the base structure and the work platform structure and comprises at least one chamber with a variable volume for pressurized medium;
pulling the work platform structure to a lowered position and keeping the work platform structure in a desired position by using at least one pulling device;
transferring the work platform structure by said cylinder to an elevated position by utilizing pressurized air enclosed in said chamber of the cylinder, wherein the pressure of the pressurized air constantly generates a force elevating the work platform structure and the load, and wherein the pressure of the pressurized air is allowed to decrease during the elevating when the length of the cylinder or the volume of the chamber of the cylinder varies; and
generating for the pulling by said pulling device a force that opposes the force generated by the pressurized air, wherein the pressure of the pressurized air is allowed to rise during the pulling when the length of the cylinder or the volume of the chamber of the cylinder varies, and
wherein at least during the elevating and lowering of the work platform structure, the cylinder and the chamber of the cylinder are configured to be without a connection to a separate pressure source or pressure reservoir.

33. The method according to claim 32, wherein, during the elevating, pressurized air is utilized, which is enclosed in at least one auxiliary chamber, wherein said auxiliary chamber is further configured to be without a connection to a separate pressure source or pressure reservoir, and wherein said auxiliary chamber is connected to the chamber of the cylinder and is placed inside the work platform structure.

34. The method according to claim 32, wherein, during the elevating, pressurized air is utilized, which is enclosed in at least one auxiliary chamber, wherein said auxiliary chamber is further configured to be without a connection to a separate pressure source or pressure reservoir, and wherein said auxiliary chamber is connected to the chamber of the cylinder and is placed inside the base structure.

35. The method according to claim 32, wherein, during the elevating, pressurized air is utilized, which is enclosed in an auxiliary chamber integrated in or connected to the structure of the cylinder, wherein said auxiliary chamber is further configured to be without a connection to a separate pressure source or pressure reservoir, and wherein said auxiliary chamber is connected to the chamber of the cylinder.

36. The method according to claim 32, wherein, for loading the chamber to a predetermined pressure, air is provided with access to the chamber when the cylinder is in an extended position and after that, the chamber is closed or plugged, and thereafter the cylinder is retracted for increasing the pressure of the chamber.
